(19) United States
(12) Patent Application Publication
(10) Pub. No.: US 2010/0165567 A1
(43) Pub. Date: Jul. 1, 2010

(54) PORTABLE ELECTRONIC DEVICE WITH AN INPUT/OUTPUT MODULE TO BE DRIVEN TO LIFT FOR IMPROVING HEAT DISSIPATION WHEN OPENING THE SCREEN MODULE

(76) Inventors: Chia-cheng Shih, Taipei (TW); Xiaonan Huang, Taipei (TW); Hung-Hsiang Chen, Taipei (TW); Daniel Alenquer, Taipei (TW); Wean-Fong Loi, Taipei (TW); Tan-Wee Kiat, Taipei (TW); Luke Goh, Taipei (TW); Alec Wong, Taipei (TW); Lionel Wong, Taipei (TW)

Correspondence Address: Dr. BANGER SHIA;Patent Office of Bang Shia, 102 Lindencrest Ct., Sugar Land, TX, 77479-5201, US

(21) Appl. No.: 12/603,795

(22) Filed: Oct. 22, 2009

(30) Foreign Application Priority Data
Dec. 25, 2008 (TW) 097150568

(51) Int. Cl. G06F 1/20; G06F 1/16

(52) U.S. Cl. 361/679.48; 361/679.55; 361/679.46

(57) ABSTRACT

A portable electronic device includes a screen module, a main body module, and an input/output module. The screen module is connected with the main body module. The input/output module is electrically connected with the main body module. The input/output module is pivotally connected with the screen module and close to the bottom. When the screen module is rotated relative to the main body module to be opened, the front end of the input/output module is driven to lift to drive the input/output module to be out of a state that the input/output module abuts against the main body module. Therefore, the portable electronic device is easy to be operated. Moreover, the heat dissipation is improved to keep the internal temperature low and reduce energy consumption.

### BACKGROUND

1. Field of Invention

The invention relates to a portable electronic device and more particularly, to a portable electronic device which improves heat dissipation performance.

2. Description of the Related Art

Nowadays, a notebook computer is a very popular portable electronic device. Since the notebook computer is light, easy to keep, and the function is strong, the notebook computer gradually becomes a favorite of business people and even common players. The notebook computer mainly includes a screen module and a main body module connected with the screen module. When the notebook computer is not in operating status, the screen module covers the main body module. As a result, the screen module covers an input/output module and switches on the main body module to avoid that the input/output module, such as a keyboard and the switches are touched by mistake to turn on the computer. Furthermore, a frangible liquid crystal display (LCD) screen can be protected.

When a user wants to use the notebook computer, he rotates the screen module relative to the main body module and opens it at a certain angle to make the screen module approximately upright and convenient for vision. At the same time, the user can press the keyboard on the main body module to operate the computer or input words or symbols and so on. However, along with the trend that the notebook computer gradually becomes more and more small-sized, a heat dissipation problem becomes more important. Since components in the notebook computer are constant, and they include a motherboard, a central processing unit (CPU), a hard disk, a memory, and processing chips and so on, in a high-frequency operation, the components certainly produce high heat. However, since the whole size of the notebook computer is decreased, the notebook computer cannot additionally accommodate excessive heat dissipation elements.

Furthermore, when the notebook computer is operated, it is usually put on a flat surface such as a desktop. Most desktops are made of a material such as wood or plastic which are difficult to radiate heat. The whole main body module flatly contacts the desktop to be operated, the heat can be taken away from the bottom of the main body module is rather limited. On the other hand, the keyboard is disposed on the main body module. Since the heat is blocked by the keyboard, the heat dissipation in this direction is also not effective. At the same time, if a hot wind is forced to blow at the keyboard, when the user operates, he feels very uncomfortable.

Consequently, only side surfaces of the whole space can be provided for radiating heat. However, along with a trend that the notebook computer is gradually thin, and the thickness of the notebook computer is gradually decreased, heat dissipation performance is greatly decreased. As a result, the whole temperature become high, the performance of the notebook computer is reduced, and the notebook computer needs more energy to operate. At present, a high-speed fan is commonly utilized to maintain a heat dissipating capacity. However, once a fan speed is increased, the needed power also increases. At the same time, the noise generated by the rotation of the fan is multiplied.

### SUMMARY OF THE INVENTION

The invention discloses a portable electronic device. The portable electronic device includes a main body module, a screen module, and an input/output module. A bottom of the screen module is pivotally connected with the main body module. The input/output module abuts against the main body module and is electrically connected with the main body module. A front end of the input/output module is pivotally connected with the screen module and close to the bottom of the screen module. When the screen module is rotated relative to the main body module to be opened, the front end of the input/output module is driven to lift to form a gap between the input/output module and the main body module to make the input/output module be out of a state in which the input/output module abutting against the main body module. Thus, a radiating performance of the main body module can be improved.

On the other hand, a plurality of dissipating holes may be formed at the position of the main body module corresponding to the input/output module. Cooperating with a recess of the main body module, the recess has the dissipating holes to form a heat dissipation flow field to allow airflow to pass through the main body module. Thus, the heat dissipation performance can be further improved. A dissipating fan may be disposed at the recess of the main body module. Cooperating with the back of the main body module which is an inclined surface connected with the recess, even the main body module is put on a flat surface such as a desktop to operate, the dissipating fan can also allow air to enter the recess via the inclined surface to blow at the inner side of the main body module to maintain a better flow field design.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a portable electronic device according to an embodiment of the invention;

FIG. 2 is an exploded diagram showing a portable electronic device according to an embodiment of the invention;

FIG. 3A to 3C are schematic diagrams showing actions of a portable electronic device according to an embodiment of the invention;

FIG. 4 is a schematic diagram showing a back of a main body module of a portable electronic device according to an embodiment of the invention; and

FIG. 5 is a schematic diagram showing a back of a main body module of a portable electronic device according to another embodiment of the invention.

### DETAILED DESCRIPTION OF THE INVENTION

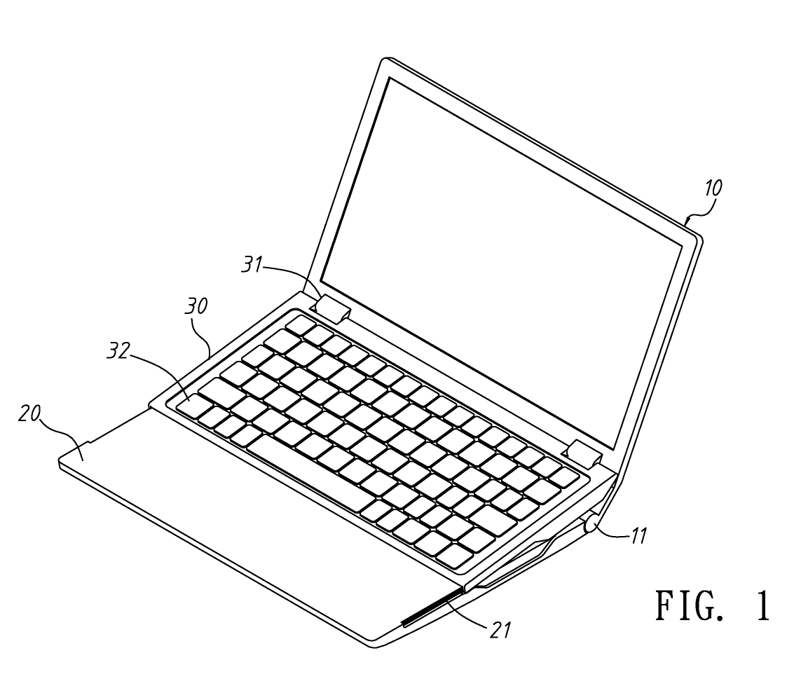

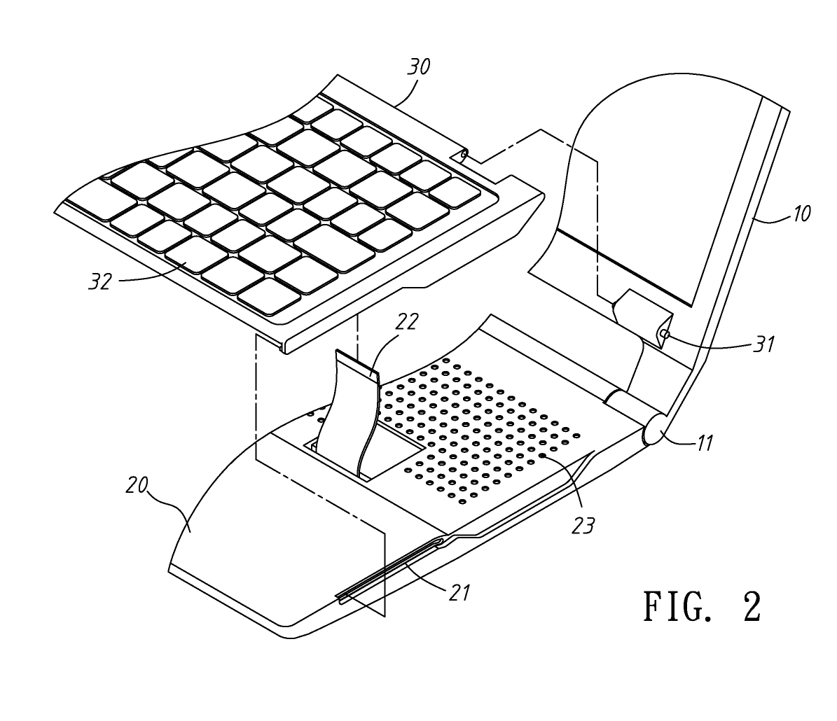

FIG. 1 and FIG. 2 are exploded diagrams showing a portable electronic device according to an embodiment of the invention.

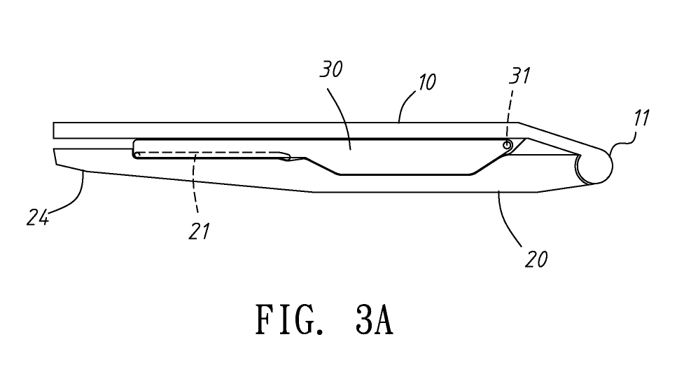

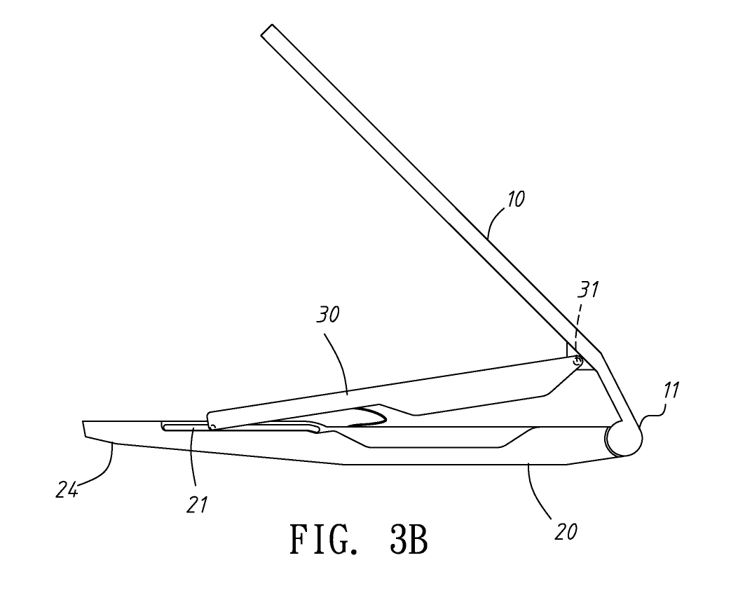

The portable electronic device according to the invention includes a screen module 10, a main body module 20, and an input/output module, such as a keyboard, a speaker, a touchpad and etc. In the embodiment of the invention, the keyboard 30 is taken as an example, but it is not limited. The main body module 20 includes electronic components such as a motherboard, a CPU, a hard disk, a memory, and processing chips therein to process electronic data. The screen module 10 has a bottom 11, and it is pivotally connected with the main body module 20 via the bottom 11 to rotate relative to the main body module 20. Then, the screen module 10 is allowed to be opened in operation state (as shown in FIG. 1) or be superposed on the main body module 20 in a keeping state (as shown in FIG. 3A).

The keyboard 30 has keys 32 thereon. The front end of the keyboard 30 is pivotally connected with the screen module 10 via a pivot 31 and is close to the bottom 11. The back end of the keyboard 30 is disposed at a rail 21 of the main body module 20. The keyboard 30 utilizes a connecting cable 22 to be electrically connected with the main body module 20. In FIG. 2, the position of the connecting cable 22 is just taken as an example. The connecting cable 22 also may be designed to be connected with the main body module 20 via the pivot 31 at the front end of the keyboard 30 or the bottom 11 of the screen module 10 to make the connecting cable 22 unexposed, and thus an overall appearance is not affected.

FIG. 3A to 3C are schematic diagrams showing actions of a portable electronic device according to an embodiment of the invention.

As shown in FIG. 3A, when the portable electronic device is in the keeping state, that is, the portable electronic device is not in use, the screen module 10 is contactually superposed on the main body module 20, and the keyboard 30 also abuts against the main body module 20. As a result, not only the portable electronic device is easy to keep, but also the screen module 10 and the keys 32 on the keyboard 30 can be protected. When the user wants to use the portable electronic device, as shown in FIG. 3B, he rotates the screen module 10 relative to the main body module 20 around a pivotal part of the bottom 11 to open the screen module 10. At the time, since the front end of the keyboard 30 is pivotally connected with the screen module 10 via the pivot 31, and the pivotal connection position is very close to the bottom 11, along with opening of the screen module 10, the front end of the keyboard 30 is driven by the screen module 10 to lift. Since the back end of the keyboard 30 is disposed at the rail 21 of the main body module 20, it is restricted by the rail 21 to slide along the rail 21.

Afterwards, the screen module 10 is opened. Finally, the screen module 10 is opened to an opening limit portion, and the back end of the keyboard 30 also slides to an end of the rail 21 as shown in FIG. 3C to present an using operation state. At the time, since the keyboard 30 is lifted by the screen module 10, a gap G can be formed between the keyboard 30 and the main body module 20. Since the keyboard 30 does not abut against the main body module 20, the heat dissipation performance of the main body module 20 can be improved. As shown in FIG. 3A to 3C, in this embodiment, via guidance of the rail 21, the back end of the screen module 10 slides more smoothly. The portable electronic device also may be designed without the rail to make the opening angle of the screen module 10 not restricted.

On the other hand, as shown in FIG. 1, dissipating holes 23 are formed correspondingly to the position of the keyboard 30 on the main body module 20. The heat produced from the electronic components in the main body module 20 can be radiated out to improve the heat dissipation performance. On the other hand, since the front end of the keyboard 30 is lifted by an angle, the whole keyboard 30 presents a bevel in the operation state, and the user may input words and symbols and operate more conveniently. The size of the gap G is determined by the position of the pivot 31 at the front end of the keyboard 30 relative to the bottom 11 of the screen module 10. The size of the gap G can be controlled by changing the position of the pivot 31 according to considerations for an operation angle or the heat dissipation performance.

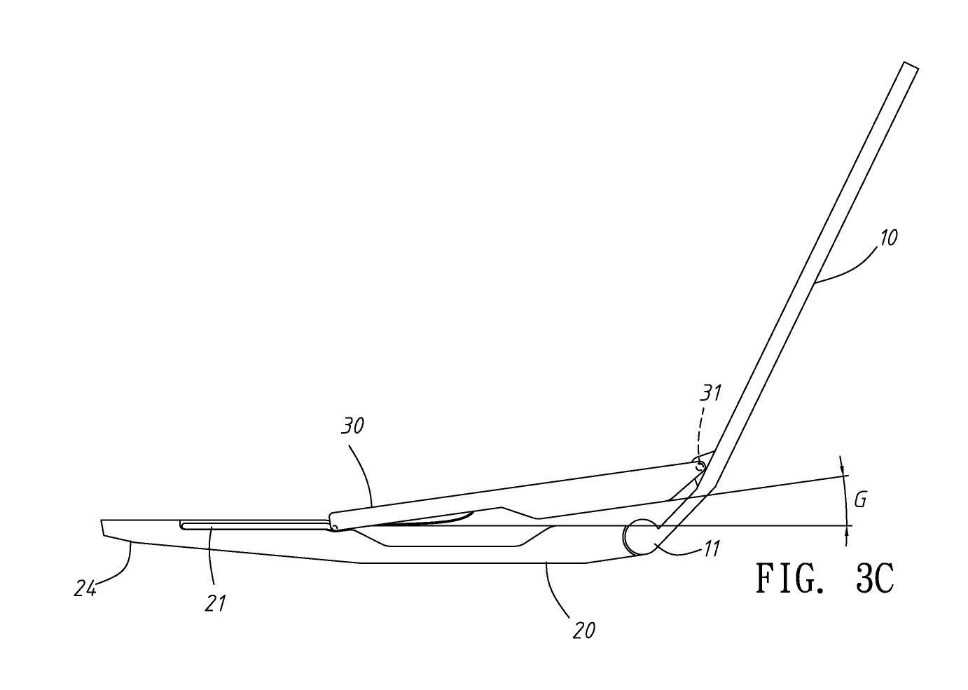

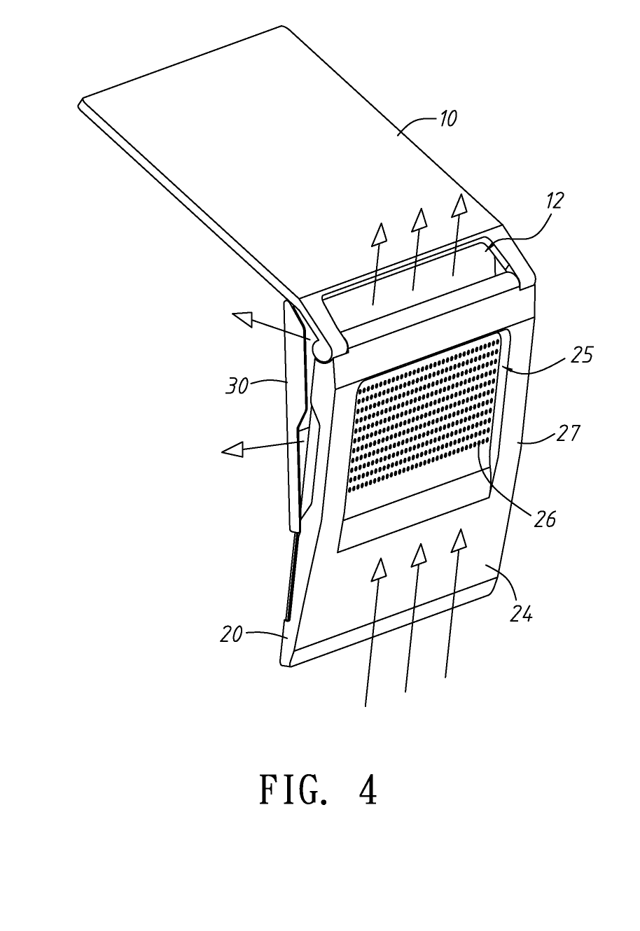

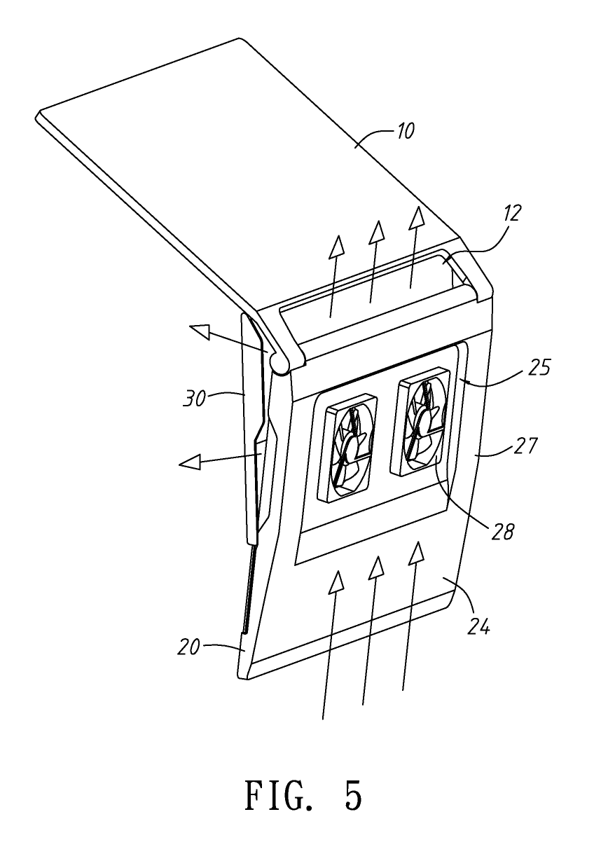

FIG. 4 and FIG. 5 are schematic diagrams showing a back a portable electronic device according to embodiments of the invention.

When the portable electronic device is used, a back 27 of the main body module 20 is disposed on the flat surface such as the desktop to be operated. Most desktops are made of a material such as wood or plastic whose thermal conductivity is low. Thus, the heat dissipation performance at the back 27 is very poor. As a result, a recess 25 is formed at the back 27. As shown in FIG. 4, the recess 25 is approximate at the position of the back 27 of the main body module 20 corresponding to the keyboard 30. The recess 25 has dissipating holes 26 thereon. Consequently, the dissipating holes 26 with the dissipating holes 23 (as shown in FIG. 1) under the keyboard 30 can form an air circulation path. Air may enter the dissipating holes 26 at the back 27 of the main body module 20, pass through the interior of the main body module 20, and then be released from the above dissipating holes 23 to take away the heat effectively.

On the other hand, considering that the back 27 is contactually put on the desktop, the inclined surface 24 connected with the recess 25 is designed at the back 27 of the main body module 20 to allow the air to easily enter into the recess 25. The inclined surface 24 can be designed at any position of the back 27 or changed to an air channel as long as the air easily enters the recess 25.

After the air is released from the dissipating holes 23, it escapes via left and right sides of the space under the keyboard 30. The air is blocked by the screen module 10 at the front, and thus it is not easy to radiate heat. Not only the heat dissipation performance is affected, but also an air direction may be changed to blow the air at the keyboard 30, which may affect the operation of the user. Consequently, the hollow portion 12 can be formed near the bottom 11 of the screen module 10 to allow the air to escape through the front.

As shown in FIG. 5, to further improve the heat dissipation performance, at least a dissipating fan 28 may be disposed in the recess 25 to forcibly push airflow to further improve the heat dissipation performance. Similarly, the position of the dissipating fan 28 is not limited to in the recess 25, and it may be disposed in the main body module 20 or other positions. The guide direction of the airflow also may be changed.

As a result, in the portable electronic device, since along with the opening of the screen module, the front end of the keyboard is lifted to make the keyboard out of a state in which the keyboard flatly abut against the main body module, the heat dissipation performance may be increased effectively. On the other hand, the portable electronic device can be designed with the recesses, the dissipating holes, or even the dissipating fan. The heat dissipation performance can be further improved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A portable electronic device, comprising:
a main body module;
a screen module having a bottom pivotally connected with the main body module; and
an input/output module abutting against the main body module and electrically connected with the main body module, wherein a front end of the input/output module is pivotally connected with the screen module and close to the bottom of the screen module;
wherein when the screen module is rotated relative to the main body module to be opened, the front end of the input/output module is driven to lift and form a gap between the input/output module and the main body module.

2. The portable electronic device according to claim 1, wherein the main body module has a rail for disposing a back end of the input/output module.

3. The portable electronic device according to claim 1, wherein a plurality of dissipating holes are formed at the position of the main body module corresponding to the input/output module.

4. The portable electronic device according to claim 1, wherein a recess is formed on a back of the main body module.

5. The portable electronic device according to claim 4, wherein a plurality of dissipating holes are formed at the recess of the main body module.

6. The portable electronic device according to claim 4, wherein a dissipating fan is disposed at the recess of the main body module.

7. The portable electronic device according to claim 4, wherein the back of the main body module is an inclined surface connected with the recess.

8. The portable electronic device according to claim 1, wherein a hollow portion is formed on the bottom of the screen module.
